(19) United States
(12) Patent Application Publication
(10) Pub. No.: US 2025/0066000 A1
(43) Pub. Date: Feb. 27, 2025

(54) Navigation Aiding Method and Apparatus

(71) Applicant: Norwegian Defence Research Establishment, Kjeller (NO)

(72) Inventors: Kenneth Gade, Kjeller (NO); Stig A. V. Synnes, Kjeller (NO); Torstein O. Sæbø, Kjeller (NO); Einar Berglund, Kjeller (NO); Per Espen Hagen, Horten (NO)

(21) Appl. No.: 18/726,553

(22) PCT Filed: Dec. 23, 2022
(86) PCT No.: PCT/NO2022/050328

§ 371 Date: Jul. 3, 2024

(30) Foreign Application Priority Data
Jan. 5, 2022 (NO) 20220014

(51) Int. Cl. B63G 8/00; G01S 7/52; G01S 15/60; G01S 15/89

(52) U.S. Cl. CPC B63G 8/001; G01S 7/52004; G01S 15/60; G01S 15/8902; B63G 2008/004

(57) ABSTRACT

Navigation aiding method and apparatus for enhanced navigation of a marine platform over a seafloor, wherein using micronavigation displacement measurements and an estimator to improve the navigation data of the marine platform.

### BACKGROUND

The disclosed embodiments relate to a navigation aiding method and an associated navigation aiding apparatus.

The technique of synthetic aperture sonar (SAS) imaging was first disclosed in U.S. Pat. No. 3,484,737 A (Walsh, 1968), where the technique of synthetic aperture radar was adapted to operate on the comparatively slowly propagating acoustical waves in water by use of multi-element receiver arrays.

The imaging performance achievable using acceleration measurements of an inertial navigation system (INS) was assessed in “Comparison of sonar system performance achievable using synthetic-aperture techniques with the performance achievable by more conventional means” (Cutrona, 1975). Soon thereafter U.S. Pat. No. 4,244,036 A (Raven, 1978) proposed to use data collected by the SAS system to improve on the navigation available from an INS, and a more generalized solution was provided with U.S. Pat. No. 4,244,026 A/EP 0010974 B1 (Dickey, 1978). The overall technique involves cross correlating element data from two successive pings using relatively short echo timeseries from a patch of the seafloor, and therefrom estimating the along-track movement from the element pairs with highest coherence (or similarity), and the cross-track movement from time delay estimates.

This overall technique has become widely accepted for refining the navigation provided by INS to achieve the quality of local navigation needed for the formation of SAS images “SYNTHETIC APERTURE BEAMFORMING WITH AUTOMATIC PHASE COMPENSATION FOR HIGH FREQUENCY SONARS” (Sheriff 1992) and “Synthetic Aperture Sonar: A Review of Current Status” (Hayes and Gough, 2009), and has been termed Displaced Phase Center Antenna (DPCA) technique, the Redundant Phase Center (RPC) technique, Ping-to-Ping Cross Correlation (P2C2), and SAS micronavigation.

While successfully improving the local navigation needed to form SAS images, SAS micronavigation has yet to demonstrate the same success on improving the long-term navigation solution provided by state-of-the-art Doppler-aided INS systems with high-grade accelerometers and gyro compasses, as discussed in “Application of aided inertial navigation system to synthetic aperture sonar micronavigation” (Tesei, et al, SACLANTCEN Memorandum SM-368-UU, 2006) and “Aided inertial navigation in GPS-denied environments using synthetic aperture processing” (Dillon, Contract report DRDC-RDDC-2016-C200, 2016).

For SAS micronavigation to significantly improve the long-term navigation solution provided by state-of-the-art Doppler-aided INS systems, there is a need for adequately addressing the major assumptions and simplifications to have assumption-free estimates.

SAS micronavigation displacement measurements was suggested integrated with inertial navigation measurements, taking into account measurements of the roll and pitch angles in U.S. Pat. No. 4,244,026 A (Dickey, 1978). This was further concretized by taking into account the roll-angle related to the “line of sight” (sway) component of the micronavigation measurement in U.S. Pat. No. 6,304,513 B1 (Billon, 1998), and later by incorporating the pitch angle related to the definition of the “plane of sight” needed for accurate interpretation of the element-wise (surge) component of the micro-navigation measurement as an earth-fixed displacement in U.S. Pat. No. 10,073,175 B2 (Pinto, 2014).

Integrations of sonar micronavigation with INS that accounts for the roll-angle and lever-arms, has been demonstrated and discussed in the mentioned publications “Application of aided inertial navigation system to synthetic aperture sonar micronavigation” and “Aided inertial navigation in GPS-denied environments using synthetic aperture processing”, as well as “Application of aided inertial navigation system to synthetic aperture sonar micronavigation” (Tesei, et al, 2001), which was the first to demonstrate DCPA-aided INS. An integrated inertial navigation system supported by auxiliary navigation sensors on an AUV is described in “A toolbox of aiding techniques for the HUGIN AUV integrated internal navigation system” (Jalving et al, 2003), using a Kalman filter based on error-state models to incorporate both velocity updates and position updates. It is stated that SAS micronavigation potentially can provide revolutionary accurate velocity measurements, and the need for tight integration of these measurements is acknowledged. It is further stated that the technique is yet immature and under development, and there is no mentioning of the challenge of relating these sensor displacement measurements to the displacement of the platform. An integration of micronavigation displacement measurements into an INS system by the use of Kalman filter is presented in CN 101900558A (LI, et. Al, 2010), similar to the disclosure covered in the previously referred integrations, and further does not take into account the direction of the micronavigation displacement measurements already outlined in prior art.

In prior art, the integration of micronavigation measurements into an INS have thus been performed using an overall estimate of “process noise” and “measurement noise” for integration with the “covariance matrix of the state vector”. However, the accuracy of the individual micro-navigation displacement measurements and related orientation measurements could be estimated, for example following “Optimistic and Pessimistic Approximations to Variance of Time Delay Estimators” (Salt et al, 1989) and will provide a better means for weighting the micro-navigation updates relative to the current navigation solution.

The general concept of measuring displacement by correlating acoustic signals from consecutive transmissions in a multi-element receiver originates with U.S. Pat. No. 4,244,036 A (Raven, 1978) and EP0010974 B1 (Dickey, 1978).

In EP0010974 B1 is presented a solution for estimating the full 3D displacement for a down-looking system by estimating the direction of the acoustic return relative to a 2D array. Displacement along the line of sight is estimated from the time delay, and the displacement in the array plane from the correlating elements.

U.S. Pat. No. 4,244,036 A is based on estimating the generally sideways displacement from the time delay of a side-looking system.

U.S. Pat. No. 6,304,513 B1 (Billon, 1998) disclosing estimation of the roll angle from sonar to seafloor by using interferometry, achieving a more correct direction for the displacement related to the time delay.

The estimation of the general motion along the array with a side-looking geometry is tightly related to the disclosure of EP 0010974 B1.

However, the acoustic signals only decorrelate rapidly along axes where the acoustic footprint is wide. With a side-looking geometry, this corresponds to the general along-track direction. Therefore, only two components of displacement are available for any particular range and side with a side-looking system by correlating acoustic signals from consecutive transmissions. The magnitude of the third component of displacement remains unknown.

With a down-looking geometry, the solution of EP 0010974 B1 enabled estimation of the displacement of a 2D array relative to line of sight.

With a side-looking geometry, it is possible to estimate the displacement of a 2D array relative to line of sight and one blind direction/direction of no information. This blind direction/direction of no information is orthogonal to both the seafloor and the line of sight.

Both direction and magnitude of all three components of displacement are needed to construct a full displacement vector. With one component unknown, the displacement orthogonal to the unknown component can be assessed, but only if the direction of all three components are known.

For integration of the displacement vector into a navigation system, not only the direction and magnitude of the displacement vectors are needed, but also the accuracy of their estimated values.

With the down-looking geometry of EP 0010974 B1, the yaw angle and the pitch angle are identical, and thus only one estimate is needed. With a side-looking geometry, pitch and yaw must be estimated separately.

Other solutions dedicated to the side-looking geometry; U.S. Pat. No. 4,244,036, U.S. Pat. No. 6,304,513 B1 and U.S. Pat. No. 10,073,175 B2 (Pinto), all assume that the echo of each ping returns from the broadside direction corresponding to yaw angle of 90 degrees. U.S. Pat. No. 4,244,036 is using a presumed known roll angle, while U.S. Pat. No. 6,304,513 B1 and U.S. Pat. No. 10,073,175 B2 introduces alternative embodiments of EP 0010974 B1 for estimating either roll angle or both roll and pitch angles. The requirement of estimating yaw with the side-looking geometry is not addressed, thus reducing the accuracy in the assessment of the direction of the line of sight, and reducing the accuracy of the estimation of the blind direction/direction of no information.

Furthermore, prior art dedicated to side-looking geometry has assumed that the two axes of measurements are orthogonal (as would follow from yaw equal to zero), and applied the displacement measurements as velocity measurements valid at one specific time point.

The simplification and assumptions of the prior art solutions results in inaccuracy in the navigation system, hereunder measurement bias in the estimations and further drift in the estimated/calculated parameters.

Particularly for submerged systems where global navigation systems relying on electromagnetic signals are not available, a velocity or displacement sensor is a key component of most navigation systems. In scenarios requiring extreme accuracy over long periods of time, it is of critical importance to eliminate measurement biases, as these will accumulate and over time become the limiting factor for position accuracy.

There is accordingly a need for a navigation aiding method and apparatus providing improved long-term position accuracy compared to the prior art solutions.

There is further a need for a navigation aiding method and apparatus capable of modelling displacement measurements with higher level of accuracy than what is currently available.

There is further a need for a navigation aiding method and apparatus treating displacement measurements as non-orthogonal, as well as capable of identifying and utilizing the different coordinate frames when applying the displacement measurements in the apparatus.

There is further a need for a navigation aiding method and apparatus capable of correct handling of the different times of validity of the measurements. There is further a need for a navigation aiding method and apparatus enhancing the accuracy of other sensors carried by a marine platform.

### SUMMARY

Provided herein is a navigation aiding method and apparatus partly or entirely solving the mentioned drawbacks of prior art.

Also provided is a navigation aiding method and apparatus providing improved long-term position accuracy compared to the prior art solutions.

Also provided is a navigation aiding method and apparatus capable of modelling displacement measurements with unprecedented level of accuracy.

Also provided is a navigation aiding method and apparatus capable of treating displacement measurements as non-orthogonal.

Also provided is a navigation aiding method and apparatus capable of using different coordinate frames when applying displacement measurements in the apparatus.

Also provided is a navigation aiding method and apparatus enabling correct handling of different times.

The disclosed embodiments provide a navigation aiding method and apparatus using displacement measurement.

For the understanding of the disclosed embodiments, it is necessary to make some definitions of coordinate systems that are used in the disclosure herein.

As used herein, “line of sight” is defined as a vector spanning between a receiver array and acoustic center of a seafloor return.

As used herein, “plane of sight” is defined as the plane spanned by the line of sight and a normal vector of the seafloor.

Herein, “receiver array frame” is centered on the receiver array, with the X-axis along the main dimension of the receiver array (pointing forward), and the Z-axis spanning the secondary dimension of the 2D array.

Herein, “patch frame” is located at the acoustic center of mass for any instance of seafloor illumination, with the Y-axis along the line of sight, and the X-axis pointing along the seafloor.

Herein, “marine platform-relative frame” has its origin at a point of reference on the marine platform, with the X-axis in the forward direction, the Y-axis in a lateral direction and the Z-axis in a vertical direction.

Herein, “navigation frame” is a local coordinate system originating from lateral-longitudinal position of the marine platform on the surface of the earth at sea level, wherein Z-direction points towards center of the earth and X-direction and Y-direction rotates freely about the Z-direction.

Herein, “geographical navigation frame” is an earth-fixed coordinate system, rotating with the earth.

In one example of the Geographical navigation frame, the earth-fixed coordinate system has its origin at the center of the Earth, wherein one direction points towards north, one direction is in the plane going through equator and pointing towards 180 degrees west/east, and one direction is orthogonally on these (ECEF).

The navigation aiding method and apparatus disclosed herein provides an integrated solution for a marine platform and thus forms an acoustic micronavigation aided integrated navigation system.

The disclosed embodiments are related to the use of displacement measurement of the marine platform relative to the seafloor as the marine platform moves over the seafloor, and integrating the micronavigation displacement measurements into a navigation processor utilizing one or more other sensors.

According to the disclosure, the navigation aiding method and apparatus are configured to determine the marine platform-relative coordinate frame of the micronavigation displacement measurements in connection with integrating the mentioned micronavigation displacement measurements in the navigation processor.

The apparatus comprises at least one one-sided or two-sided sonar consisting of at least one transmitter and at least two (multi-element) receiver arrays each roughly parallel to the marine platform's direction of travel.

According to one embodiment of the navigation aiding apparatus, the receiver arrays are stacked roughly perpendicular both to the marine platform's direction of travel and to the seafloor.

The navigation aiding apparatus comprises a sonar processor configured for performing micronavigation displacement measurements between sonar transmissions and for estimating the coordinate frame for each such micronavigation displacement measurement.

The navigation aiding apparatus comprises a navigation processor configured for combining the micronavigation displacement measurements with measurements from other sensors integrated on or arranged to the marine platform, such as an Inertial Measurement Unit (IMU), a pressure sensor, and a positioning sensor such as a global navigation satellite system (GNSS) receiver for providing an initial position measurement.

By using a sonar with a side-looking geometry, estimation of the displacement of a 2D array relative to line of sight and one blind direction/direction of no information is enabled. This blind direction/direction of no information is orthogonal to both the seafloor and the line of sight, as defined above.

Both direction and magnitude of all three components of displacement are needed to construct a full displacement vector. With one component unknown, the displacement orthogonal to the unknown component can be assessed, but only if the direction of all three components are known.

For integration into a navigation aiding apparatus, not only the direction and magnitude of the displacement vectors are needed, but also the accuracy of their estimated values.

According to one embodiment, yaw angle of the line of sight is estimated, something which discriminates this side-looking geometry from the down-looking sonar geometry solutions, where the yaw angle and the pitch angle are identical.

With the side-looking sonar geometry, an estimation of the mentioned yaw angle will contribute in both accurate assessment of the direction of the line of sight, and accurate estimation of the blind direction/direction of no information.

The disclosed embodiments provide a navigation aiding method and navigation aiding apparatus correctly treating the micronavigation displacement measurements as non-orthogonal, and recognizes that several different coordinate frames are relevant for applying the micronavigation displacement measurements in the (integrated) navigation apparatus.

A navigation aiding method according disclosed herein comprises a step of performing micronavigation displacement measurements (delta positions) along the primary axes of two different coordinate systems, the receiver array frame and the patch frame.

The disclosed method further comprises calculating the complete orientation of the receiver array frame relative to the patch frame.

According to a further embodiment of the method, it further comprises calculating associated accuracies for all measurements and calculations. Another embodiment uses fixed values for the mentioned accuracies.

The navigation aiding method according to the disclosure further comprises a step of registering multiple timestamps for transmit and receive times, and addressing these during integration.

Each ping-pair from either port or starboard side yields a batch of micronavigation displacement measurements. As each measurement in a batch is associated with a patch at a particular distance away from the receiver array, each measurement is valid at a slightly different time point. The navigation aiding method comprises calculating angles for estimating patch coordinate system (to provide improved estimates of line of sight and plane of sight) and micronavigation displacement measurements for each patch measurement resulting from each successive ping-pair, on each side. The comprehensive output is needed to derive an accurate velocity update for the integrated navigation aiding apparatus.

The number of patches (per ping), constituting the mentioned batch, is configurable, and the location of the patches on the seafloor relative to the moving marine platform may be either static or dynamic.

According to a further embodiment, the navigation aiding method further comprises correlating along-track elements to estimate the azimuth direction for the line of sight.

In an alternative embodiment of the method, the navigation aiding method comprises using ping data to estimate scattering distribution over the patch to estimate azimuth direction for the line of sight.

In accordance with a further embodiment, the navigation aiding method comprises using ping data to estimate the seafloor depth at multiple azimuth directions and ranges to estimate the effective seafloor slope, and use the effective seafloor slope together with the line of sight to determine the plane of sight spanning in the Y-Z plane in the patch frame.

The navigation aiding method comprises using an estimator, such as a Kalman Filter (KF) or extended Kalman Filter, non-linear estimator, such as unscented Kalman filter, particle filter, Sensor Fusion methods, machine learning or other similar solutions. The estimator is used for modelling the relationship between navigation states of the marine platform, hereunder position, orientation, and velocity, and the micronavigation displacement measurements, coordinate frames, timings and associated accuracies. According to a further embodiment, the estimator is further used for estimating sensor errors, such as offsets and scaling errors.

According to a further embodiment of the navigation aiding method, it comprises using the estimator for modelling the relationship between navigation states of the marine platform, hereunder position, orientation, and velocity, and the measurements and/or states from additional sensors, such as an inertial measurement unit (IMU), gyrocompass or similar units.

According to a further embodiment of the navigation aiding method, it comprises using the estimator to estimate systematic errors in any measurements and calculations, including micronavigation, but not limited to, micronavigation displacement measurements and/or installation geometry.

In accordance with a further embodiment, the navigation aiding method comprises calibrating different apparatus parameters, such as micronavigation scale factor errors, transducer alignment errors, etc., by incorporating additional states in the estimator.

According to the disclosure, the navigation aiding method comprises predicting, between micronavigation displacement measurements, the different estimates and their error covariance, and updating every time a new measurement is registered.

The theoretical accuracy and full utilization of micronavigation imposes stringent requirement on the mathematical implementation and timing. The navigation aiding method according to the disclosure comprises integrating micronavigation displacement measurements that accurately incorporates and utilizes the information available without the approximations and assumptions of prior art methods.

The ultimate purpose of the herein described navigation aiding method is to utilize the micronavigation measurements to reduce velocity error and hence position error of the (integrated) navigation aiding apparatus, which in turn means reducing the position drift. Compared to conventional velocity aiding techniques (using additional sensors), micronavigation provides a higher fidelity input.

While each micronavigation displacement measurement will be linked to their own states in the estimator, the actual processing steps are the same. When considering an iteration with a single micronavigation displacement measurement, the navigation aiding method comprises, by means of a navigation processor, registering and converting the micronavigation displacement measurements (delta positions) to estimator measurements by converting displacements in specified coordinate systems, in combination with transmit and receive times, to velocities.

According to a further embodiment of the navigation aiding method, it comprises using displacement accuracies either directly or indirectly by converting displacement accuracies to velocity accuracies.

The representation in the different coordinate frames remain unchanged at this point, and the non-orthogonality will be correctly treated when carrying out lever arm compensation and the estimator, update, further described below.

The navigation aiding method, by the navigation processor, comprises performing micronavigation lever arm compensation as a part of the estimator observation model calculations. In an alternative embodiment of navigation aiding method, the lever arm compensation is performed as a part of the micronavigation displacement measurement registration.

The navigation aiding method comprises calculating the lever arm by a static part from mechanical offsets from the navigation aiding apparatus origin to the transmitter and multiple receiver arrays of the sonar, and a dynamic part due to varying overlap caused by the surge motion of the marine platform.

In this manner, the navigation aiding method, by means of the lever arm calculation, compensates for the effect the lever arm has on the micronavigation displacement measurements, and associated compensation, hereunder; angular velocity of the marine platform, intermediate rotation occurring in the duration between the disparate times of the patch orientation and the displacement measurements, and rotational misalignment of the receiver array relative to a navigation frame.

In accordance with one embodiment, the navigation aiding method, the calculated lever arm is decomposed in either the receiver array frame or patch frame, for respective mentioned micronavigation displacement measurements.

According to an embodiment, the navigation aiding method further comprises, by means of the estimator calculating corrections based on estimations of the estimator observation model and calculated accuracies in the micronavigation displacement measurements and associated coordinate frame calculations.

According to an embodiment, the accuracies in the micronavigation displacement and associated coordinate frame calculations are calculated as a function of the navigation apparatus velocity (geographical navigation frame), the micronavigation surge velocity (receiver array frame), and the micronavigation sway velocity (patch frame), all lever arm compensated. According to the disclosure, the non-orthogonality of the different displacement measurements is compensated for by the navigation processor.

According to one embodiment of the navigation aiding method, the navigation aiding method comprises adapting the micronavigation displacement measurements in the navigation frame by taking into account the intermediate rotation occurring in the duration between the disparate times of the patch orientation and the micronavigation displacement measurements.

According to a further embodiment one could also take into account the rotational misalignment of the receiver array relative to the navigation frame, and/or orientation of acoustic estimated patch coordinate system (spatial extension as well as intensity distribution).

The navigation aiding method comprises correcting the micronavigation displacement measurement in the receiver array frame by applying the orientation of acoustic estimated patch coordinate system.

According to the navigation aiding method, the accuracies in the micronavigation displacement and associated coordinate frame calculations, and the output of the mentioned estimator observation model, is decomposed in the patch frame, in two dimensions.

The navigation aiding method makes use of an estimator observation model describing the connection between the navigation states, the errors of the navigation states, and the modelled errors of the micronavigation displacement measurements and patch orientations.

In accordance with a further embodiment of the navigation aiding method, for calibration, comprising incorporating calibration states and coupling of those in the estimator.

As the navigation aiding method according to one embodiment, comprises decomposing the errors of the navigation states in the geographical navigation frame, the construction of this part of the observation matrix takes into account the same effects as in the mentioned error in the measurements derivation. In more detail, taking into account the intermediate rotation occurring in the duration between the disparate times of the patch orientation and the micronavigation displacement measurements.

According to a further embodiment, one could also take into account the rotational misalignment of the receiver array relative to the navigation frame, and/or orientation of acoustic estimated patch coordinate system (spatial extension as well as intensity distribution).

The micronavigation part of the mentioned observation matrix is according to the navigation aiding method parameterized, such as, but not limited to linearization, curve adaption/fitting, etc., around the solution of the navigation equations, and the patch angles. It includes the rotation matrix from the receiver array frame to the patch frame (constructed from the mentioned patch angles), and the derivatives of this matrix with respect to the patch angles.

In an alternative embodiment, the mentioned estimator observation matrix is implemented by a non-linear estimator, such that the mentioned parametrization is not required.

In accordance with one embodiment, the navigation aiding method comprises using a Kalman filter or an extended Kalman filter as the estimator. Similar as for the observation matrix, the navigation aiding method comprises calculating an observation noise matrix, which for the micronavigation part, is based on reported accuracies by the sonar processor, optionally in combination with configuration parameters. In more detail, the navigation aiding method according to one embodiment comprises parametrizing an observation equation around a navigation equation solution and the patch angles. Given the parameterized model, the observation noise matrix can be found using similarity transform and the accuracy of surge and sway measurements, and the patch angles.

The navigation aiding method according to one embodiment further comprises providing the corrections as input to a controller or control system controlling motion of the marine platform directly or indirectly. The corrections may be accompanied by estimator gains, such as Kalman Filter gains when a Kalman filter is used. The estimator gains are, e.g., the relative weights given to the measurements and current state estimates.

The above described navigation aiding method may be modified according to the different application.

In accordance with one embodiment, the navigation aiding method according to a further embodiment comprises converting the micronavigation displacement measurements (delta position) to a velocity measurement applicable in a preset/desired time interval. This embodiment may further be improved by using inertial measurement unit measurements, e.g., to modify or correct the time of measurement to a better place than the preset/desired time interval. For marine platforms experiencing only low-accelerating movements, the error of this method is rather small.

In another application modification with focus on handling accelerations of the marine platform in a better manner, one may assume that errors develop slower than the full states. For such an application, the navigation aiding method comprises estimating an expected micronavigation displacement measurement (delta position) by integrating inertial measurement unit measurements (navigation equations), and comparing the two. A further advantage with this embodiment is that no new states are needed to be added in the estimator observation model.

According to a further embodiment the navigation aiding method comprises using micronavigation displacement measurements (delta position) close to optimal by using extra states to “remember the position and its correlations” from start to completion of a micronavigation displacement measurement. An advantage with this embodiment is that very few assumptions are required.

Accordingly, provided herein is a navigation aiding method and apparatus making use of displacement measurements from a sonar to improve the real-time navigation of a marine platform over the seafloor. By providing improved real-time navigation of the marine platform also enhanced and more precise controlling of a marine platform over the seafloor is achieved.

Especially, the disclosed embodiments contribute in reducing position drift.

A navigation aiding apparatus based on the principles of the navigation aiding method will be described in detail below.

### BRIEF DESCRIPTION OF THE DRAWINGS

The present invention will below be described in further detail with references to the attached drawings, where:

FIG. 1 is a principle drawing of a navigation aiding apparatus according to the disclosure,

FIG. 2 is a principle drawing of a marine platform with a sonar moving over the seafloor and associated coordinate systems,

FIG. 3 is a principle drawing of geometry and timing of micronavigation displacement measurements,

FIG. 4 is a principle drawing of sway displacement measurements relative line of sight, and

FIG. 5 is a principle drawing of surge displacement measurement relative plane of sight.

### DETAILED DESCRIPTION

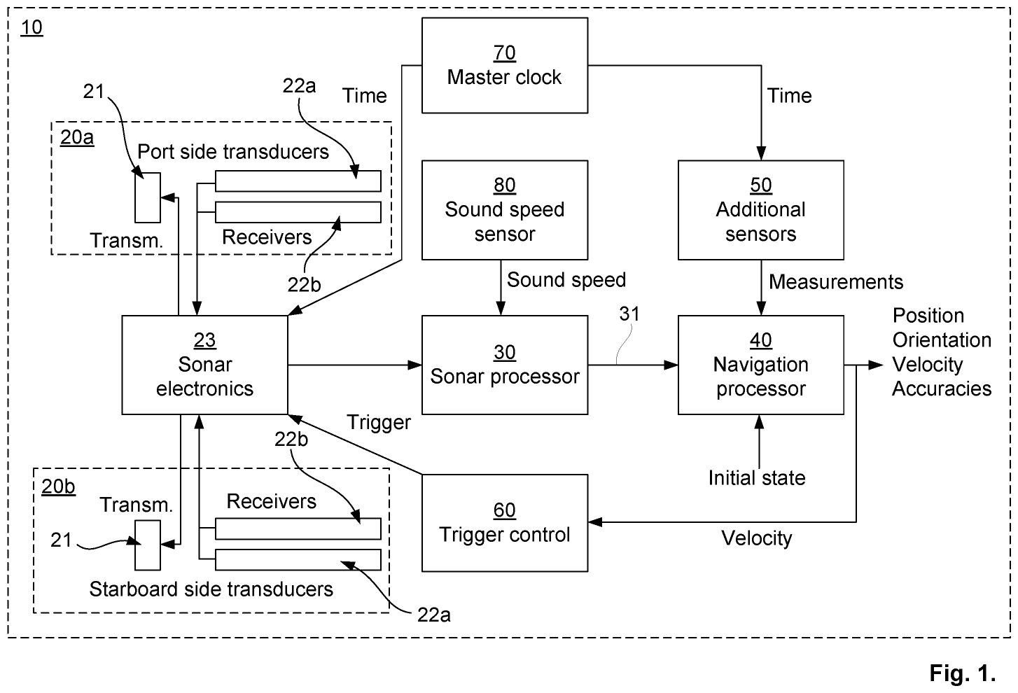

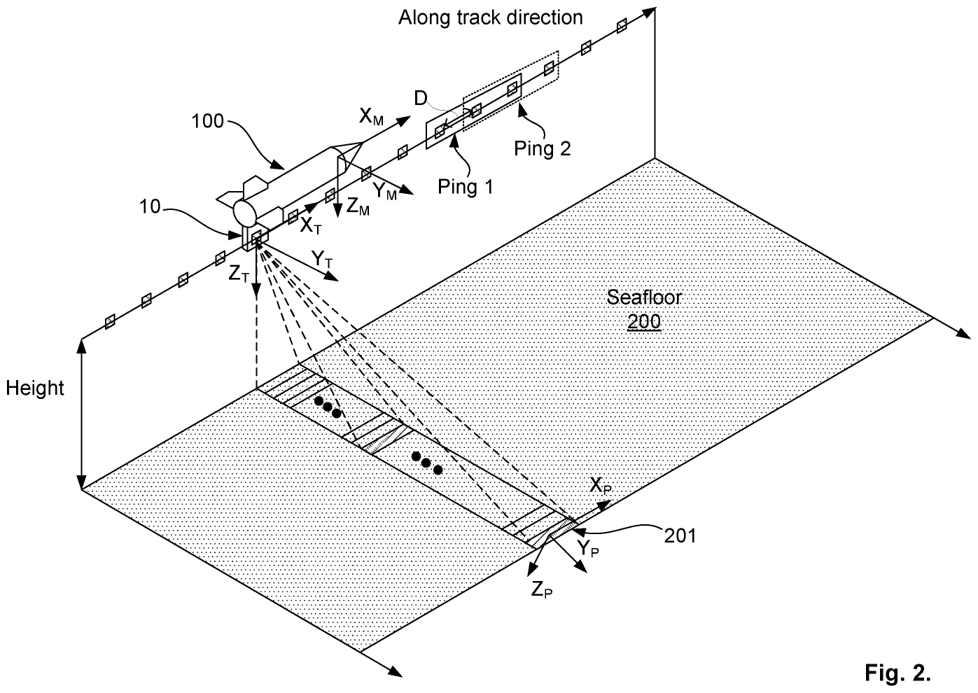

Reference is now made to FIGS. 1 and 2. FIG. 1 is showing a principle drawing of a navigation aiding apparatus 10 is adapted for being arranged to or integrated in a marine platform 100. FIG. 2 shows the navigation aiding apparatus 10 arranged to the marine platform 100 moving over a seafloor 200, as well as associated coordinate systems.

The marine platform 100 is typically an underwater, submersible or semi-submersible vehicle moving over the seafloor 200 by a desired height and generally in a forward direction. The marine platform 100 is typically an autonomous or semi-autonomous vehicle.

The marine platform 100 will be provided with controllable propulsion means (not shown) or towed by a vessel or craft with propulsion means enabling semi-autonomous or autonomous controlled movement of the marine platform 100 in the water. The navigation aiding apparatus 10 may be used both for enhanced navigation information or as input for controlling the marine platform 100 or vessel or craft towing the marine platform 100.

In the latter case, the marine platform 100 or vessel or craft comprises a controller or control system (not shown) in communication with the navigation aiding apparatus 10 controlling the respective propulsion means. The propulsion means and controller or control system are well known for a skilled person and does not need any further disclosure herein.

In FIG. 2 are shown the following coordinate systems are shown:
a receiver array frame X_{T}, Y_{T}, Z_{T} centered on the receiver array of the navigation aiding apparatus 10, with the X-axis along the main dimension of the receiver array (pointing forward), and the Z-axis spanning the secondary dimension of the 2D array;
a patch frame X_{P}, Y_{P}, Z_{P} located at the acoustic center of mass for any instance of seafloor 200 illumination, with the Y-axis along the line of sight, and the X-axis pointing along the seafloor 200;
a marine platform-relative frame X_{M}, Y_{M}, Z_{M} having its origin at a point of reference on the marine platform 100, with the X-axis in the forward direction, the Y-axis in a lateral direction and the Z-axis in a vertical direction.

Geographical navigation frame, navigation frame, line of sight and plane of sight has been defined above.

The navigation aiding apparatus 10 is configured for performing the micronavigation displacement measurements of the marine platform 100 relative to a seafloor 200 the marine platform 100 is moving in relation to. The navigation aiding apparatus 10 is further configured to integrate these micronavigation displacement measurements into a navigation processor 40 of the marine platform 100, optionally in combination with one or more additional sensors 50, if present, further described below.

The navigation aiding apparatus 10 is further configured to determine the marine platform-relative coordinate frame of the micronavigation displacement measurements.

The navigation aiding apparatus 10 comprises at least one one-sided or two-sided sonar configured to be carried by the marine platform 100. In the shown embodiment, the sonar is a two-sided sonar having a port side transducer 20a and a starboard side transducer 20b. Each transducer 20a-b consists of at least one transmitter 21, and at least two multi-element receiver arrays 22a-b arranged each roughly in parallel to the travel direction of the marine platform 100. The receiver arrays 22a-b are typically stacked roughly perpendicular to the travel direction of the marine platform.

The navigation aiding apparatus 10 further comprises a sonar processor 30 configured for performing micronavigation displacement measurements between sonar transmissions and the coordinate frames for each such measurements. The navigation aiding apparatus 10 further comprises a navigation processor 40 provided with means and/or software for calculating accuracies in the micronavigation displacement and orientation measurements and an estimator observation module using the micronavigation displacement measurements. The navigation processor 40 is further provided with means and/or software for calculating corrections based on estimations of the estimator observation model and the calculated accuracies in the micronavigation displacement and orientation measurements for correction of navigation data for the marine platform 100.

The navigation processor 40 according to a further embodiment is configured for combining the micronavigation displacement measurements with measurements from additional sensors 50 arranged to or integrated in the marine platform 100. Examples of additional sensors 50 are, but not limited to, one or more of: an Inertial Measurement Unit (IMU), a pressure sensor, and a positioning sensor such as a global navigation satellite system (GNSS) receiver for providing an initial position measurement.

The navigation aiding apparatus 10 further comprises a sonar electronics unit 23 connecting the mentioned at least one transmitter 21 and at least two receiver arrays 22a-b of the transducers 20a-b to the mentioned sonar processor 30 as well as to a trigger control unit 60 and master clock 70. The sonar electronics unit 23, among other functions, is configured to provide the time of transmit and time-stamped time series data from all sonar receive channels to the sonar processor 30. The mentioned navigation processor 40 is connected to the sonar processor 30 and configured to receive micronavigation displacement measurements and coordinate frame along with their associated accuracies and time stamps.

The trigger control unit 60 is connected to the navigation processor 40 and generates a trigger signal each time the marine platform and navigation aiding apparatus 10 has travelled an estimated distance D (FIG. 2) (less than half the along-track length L (not shown) of the sonar receiver arrays 22a-b) in an earth fixed coordinate system. The trigger control unit 60 is configured to control the trigger signal for the at least one transmitter 21 based on velocity estimates from the navigation processor 40.

The sonar electronics unit 23 is configured to cause at least one transmitter (TX) 21 to ping (emit a waveform into the water) when a trigger is received from the trigger control unit 60. Each receiver (RX) array 22a-b consists of N separate elements spread over its length. The sonar electronics unit 23 is further configured to record and digitize, at a suitable frequency and resolution, the full time series from each receiver element of each receiver array 22a-b.

The navigation aiding apparatus 10 according to a further embodiment comprises a sound speed sensor 80 measuring local speed of sound in the water and/or is configured to use a measure of the local speed of sound provided by the navigation processor 40, as an input to the sonar processor 30.

The role of the master clock 70 is to facilitate precise time-stamping of transmit time, received data, and data from the additional sensors 50, if present.

The sonar processor 30 is provided with means and/or software for performing correlation of signals between overlapping phase centers.

Herein, a phase center is defined as the midpoint between the transmitter 21 and one receiver array 22a-b element. An overlapping phase center for a given ping is a phase center that has roughly the same position as a phase center from the previous ping.

The sonar processor 30 is, according to one embodiment, provided with means and/or software to provide an estimate of across-track displacement through correlating time series from the overlapping phase centers. The time delay is properly corrected for 3D geometry and transmitter-receiver baseline.

The sonar processor 30 is provided with means and/or software for providing an estimate of along-track platform displacement by comparing correlation of time series with different displacements. The generally decimal number M of overlapping phase centers between two consecutive pings is defined as M=L−2D/d, where L is the length of the receiver array 22a-b, D is the surge displacement, and d is the receiver element spacing. The direction of the across-track displacement may vary from near-vertical at short range to near-horizontal at long range from the seafloor 200.

The sonar processor 30 is provided with means and/or software for combining measurements from different ranges to provide information about micronavigation displacement along all three axes.

For the navigation processor 40 to utilize the micronavigation displacement measurements from the sonar processor 30, the sonar processor 30 is provided with means and/or software for finding the direction of each micronavigation displacement measurement and addressing these during integration, by performing further correlations.

The sonar processor 30 is, according to a further embodiment, provided with means and/or software for correlating time series from the upper and lower receiver arrays, with data beam-formed in a given azimuthal direction and corrected for shift and dilation between the receiver arrays 22a-b providing calculation of the angle from the sonar transducers 20a-b to the seafloor 200 in that directions.

The sonar processor 30 is, according to a further embodiment, provided with means and/or software for performing the mentioned calculations at multiple across-track ranges to calculate the across-track slope of the seafloor 200.

The sonar processor 30 is, according to a further embodiment, provided with means and/or software for performing the mentioned calculations with data beam-formed in different azimuthal directions to calculate the along-track slope of the seafloor 200.

In accordance with a further embodiment, the sonar processor 30 is provided with means and/or software for determining the distribution of echo strength as a function of azimuth angle.

The sonar processor 30 is configured to use the results of these computations to accurately determine the directions of the micronavigation displacement measurements.

According to a further embodiment of the sonar processor 30 it is provided with means and/or software to estimate the accuracy of the micronavigation displacement and direction measurements through further computations, using the normalized cross-correlation coefficients.

The resulting calculations (measurements), their directions and accuracies are used as input to the navigation processor 40 for further processing and use.

The navigation processor 40, according to one embodiment, is built around an estimator, such as a as a Kalman Filter (KF) or extended Kalman Filter, non-linear estimator, such as unscented Kalman filter, particle filter, Sensor Fusion methods, machine learning or other similar solutions.

The estimator is used for modelling the relationship between navigation states of the marine platform 100, hereunder position, orientation, and velocity, and the micronavigation displacement measurements, coordinate frames, timings and associated accuracies. According to a further embodiment of the navigation processor 40, the estimator is used for estimating sensor errors, such as offsets and scaling errors.

The further description will be based on an extended Kalman filter (EKF) as a non-limiting example of implementation of the estimator.

In the example where the estimator is an extended Kalman filter, each component in a state vector represents an error of a specific measurement series. For each measurement, an equation is computed that relates the measured parameter and its estimated standard deviation to filter states and covariance matrix.

For each ping, a number of measurements are computed in the sonar processor 30 and used in a series of updates in the navigation processor 40, where they are weighted against the predicted filter states at the same time. The different micronavigation displacement measurements from a single pair of pings are generally valid at slightly different time points. After an update, the values of the filter state estimates and the covariance matrix are predicted until the next available measurement, whether it is a new micronavigation displacement measurement or a measurement from the additional sensors 50.

The output of the navigation processor 40 is an estimate of the marine platform's 100 position, orientation, velocity and angular rates at any given time; as well as the variance of each of these values and the covariances between each pair of values.

As mentioned above, the sonar processor 30 measures displacement by correlating acoustic signals from consecutive transmissions recorded in the receiver arrays 22a-b.

The displacement component estimated from the temporal shift is denoted sway displacement (DPCA-sway), and the displacement component related to the spatial shift is denoted surge displacement (DPCA-surge). While the displacement magnitudes have been addressed thoroughly before, the directions of these displacement estimates have been based on presumptions and oversimplifications. The disclosed embodiments, as will be described in detail below, provide a precise treatment of these directions of the micronavigation displacement measurements.

Important times are the two times of transmit and reception for each ping. The time of reception for the last ping is according to one embodiment chosen such that the echo from the second ping provides the maximum correlation with the echo from the first ping on the overlapping elements or range intervals of choice or patch. Important directions are the direction of the two echoes at their times of reception. The direction of each echo is a function of both transmitter 21 direction at time of transmission, transmitter shape, seafloor tilt and scatterer distribution, receiver direction at time of reception and receiver shape.

The time delay estimates are properly corrected for 3D geometry and transmitter-receiver baseline.

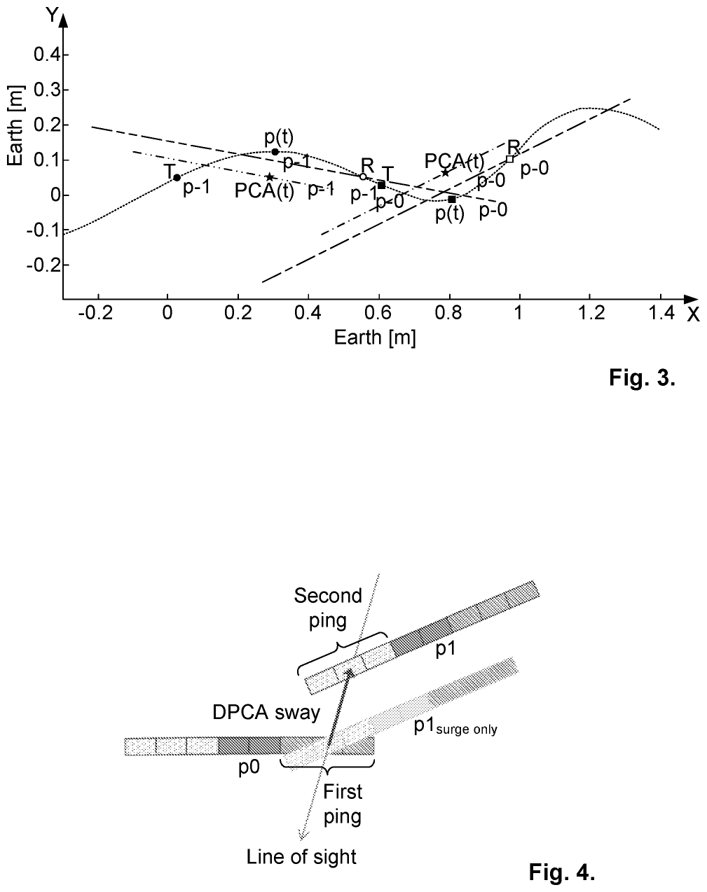

Reference is now made to FIG. 3 showing a principle drawing of geometry and timing of displacement measurements. In FIG. 3 is shown an illustration of the transmitter position tracked with a dashed black line over two pings. Transmitter positions at time of transmission (T) and at the time of reception (R) are indicated on the line. For the times of reception, the receiver positions are also illustrated (transparent). The first and second pings are shown with different fill pattern. The position of the transmitter-receiver phase center array, at the average position between the transmitter 21 and the receiver array 22a-b, is also shown using full filling. This is the effective transmitter-receiver position.

### Magnitude of Sway Displacement Measurement

The technique provides measurements on the change of round-trip-time between signals reflected off the same patch on the seafloor 200. The time delay is estimated by correlating acoustic signals from consecutive transmissions. This time delay is converted to a displacement, defined as the sway displacement measurement DeltaR_Slantrange, after multiplying with the local sound speed in the sonar processor 30.

### Magnitude of Surge Displacement Measurement

The technique also provides measurements identifying the receiver array 22a-b elements with maximum correlation between consecutive transmissions. The sub-element position of maximum correlation is estimated through interpolation. The number of elements of separation is converted to an along-track displacement, defined as the surge displacement measurement DeltaX_Body, after multiplying with half the receiver array element spacing by the sonar processor 30.

### Direction of Sway Displacement Measurement

The sway displacement measurement estimates the displacement towards or from the acoustic center-of-mass for the correlated part of the two seafloor 200 echoes.

A unit vector y_Patch(n,t) points from one receiver element (n) towards the center-of-mass of its recorded seafloor 200 echo at the time of reception (t). According to one embodiment, the direction of the sway displacement measurement is chosen to approximate the direction of sway displacement to be the average of y_Patch estimated for the overlapping elements of two consecutive pings.

In an alternative embodiment, the y_Patch is estimated from any elements from either pings.

According to one embodiment, one consider DeltaY_Patch_eff≈DeltaR_Slantrange.

For each ping, y_Patch is a function of position and orientation at transmit time, position and orientation at receive time, transmitter 21 position, receiver array 22a-b element position, transmitter shape, receiver shape, seafloor tilt and seafloor 200 scatterer distribution.

However, the direction of y_Patch(n,t) is according to one embodiment obtained by two estimates of the direction of arrival at time (t) with different reference axes. Two such estimates are:
i) The angle of arrival on the receiver array 22a-b, which can be estimated from the time delay of receptions on neighbor elements on one receiver array 22a-b.
ii) The angle of arrival on the interferometric axis, which can be estimated from the time delay between receptions on adjacent elements from the two receiver arrays 22a-b.

Prior art solutions have defined the line of sight as the direction broadside to the receiver array 22a-b and pointing towards the seafloor 200 at a given range. This approximation corresponds to setting the angle of arrival on the receiver array 22a-b to 90 degrees, and will match the acoustic measurements only when the seafloor 200 is both homogeneous and parallel to the receiver array 22a-b. The approximation might not constitute a large error for narrow-beam systems, but will give origin to a large bias when it is integrated up, and can thereby affect the long-term navigation.

The sway displacement measurement relative to the line of sight is illustrated in FIG. 4, wherein sway displacement measurement is illustrated on an 8-element phase center array, as would follow from an 8-element receiver array 22a-b, with three overlapping elements.

### Direction of Surge Displacement Measurement

It has been established before that the echo from any range decorrelates most rapidly with displacements along the dimension where the signal footprint has the largest span. Thus, the echo from a side-looking sonar with a limited field of view will decorrelate rapidly along the general direction of the seafloor 200, and most slowly with motions orthogonal to a flat seafloor 200.

The surge displacement measurement estimates the displacement across the plane of maximum correlation. This plane is sometimes called the plane of sight. When a surface normal can be established, this plane of sight is spanned by the surface normal and the line of sight (direction of sway displacement).

The assessment of the plane of sight is refined by using an improved estimate of the line of sight (direction of sway displacement). It has been noted in prior art, e.g., U.S. Pat. No. 10,073,175 B2 (Pinto), that the plane of sight can be estimated from its intersection with the receiver plane by correlating elements from an upper receiver array 22a-b with elements from a lower receiver array 22a-b. According to one embodiment, the plane of sight is estimated from the plane spanned by the line of sight-as defined herein-and the normal vector of the seafloor 200. Beams from each of the vertically displaced receiver arrays 22a-b are formed in a multitude of azimuth directions, wherein these are used to generate a mesh of bathymetric estimates, and wherein assigning a surface to the estimates and obtaining the surface normal. In one embodiment, the distribution of echo strength as a function of azimuth angle can be incorporated in the estimate of the normal direction of the seafloor 200 scattering to further improve the estimate of the plane of sight.

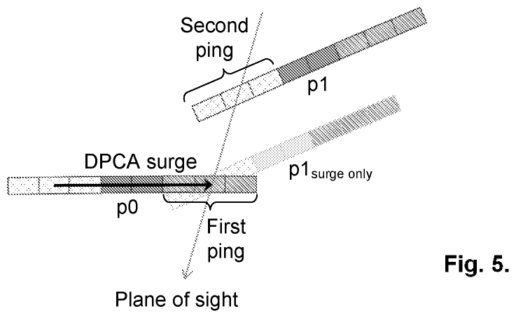

FIG. 5 shows the surge displacement measurement relative to the plane of sight. It is apparent that the surge displacement measurement has components both orthogonal to the plane and in the plane, and that the surge displacement is not generally orthogonal to sway displacement, as has been assumed previously. According to one embodiment, this is accounted for when integrating the micronavigation displacement measurements with the navigation aiding apparatus 10.

Within the plane of sight, the sway displacement measurement is along the direction of line of sight. One thus has no measurements on the displacement in its orthogonal direction within the plane of sight. Because this constitutes an unknown motion, the disclosed embodiments comprise decomposing also the surge displacement into components orthogonal to and along this direction of no information/blind direction, where after only the components orthogonal to the direction of no information/blind direction is integrated into the navigation aiding apparatus 10.

Accordingly, the micronavigation displacement measurements denote the combined surge displacement measurement and sway displacement measurement between two consecutive pings, while the associated coordinate frame calculations denote the measurements of the three angles that are needed to relate the micronavigation displacement measurements to the displacement of the sensor relative to the Earth.

Accordingly, the disclosed embodiments utilize micronavigation displacement measurements in the navigation processor 40 for providing enhanced navigation data for the marine platform 100, and hence also enhanced controlling of the motion of the marine platform 100.

The micronavigation output 31 (FIG. 1) from the sonar processor 30, contains the micronavigation displacement measurements (delta positions) along primary axes of two different coordinate systems which are receiver array 22a-b frame and patch frame. The micronavigation output 31 further contains the complete orientation of the receiver array 22a-b frame relative to the patch frame, as well as associated accuracies for all the latter quantities.

The output 31 of the sonar processor 30 also includes multiple timestamps for transmit and receive times, and addressing these during integration. A batch of micronavigation displacement measurements from a ping are generally from slightly different time points. In addition, patch angles are preferably calculated for each ping, while delta positions are calculated for each pair of successive pings. The comprehensive output is needed when deriving a velocity update for the integrated navigation aiding apparatus 10.

A single instance or package from the output 31 can be data from either port or starboard side transducers 20a-b, associated with a patch at a particular distance from the receiver array 22a-b.

The number of patches (per ping) is configurable, and the location of the patches on the seafloor 200 relative to the moving marine platform 100 can be either static or dynamic (changing based on measurement geometry and estimation performance, such as, but not limited to, recent measurement performance of the patches, predicted quality of segments 201 of the seafloor 200, based on, e.g., statistical analysis of the sonar data).

The navigation processor 40 is arranged to allow any number of patches to be utilized. If required due to computational limitations (depending on the navigation processor 40 hardware specifications), the navigation processor 40 according to a further embodiment comprises a tracker and decorrelation scheme allowing states in the navigation filter of the navigation processor 40 to be shared by multiple micronavigation displacement measurements, hence reducing the dimension of the navigation filter of the navigation processor 40.

According to one embodiment, the navigation filter of the navigation processor 40 is built around an estimator in the form of a linearized error state Kalman Filter (KF). In a further embodiment of the navigation processor 40 the navigation filter is based on a higher order filter, and a reformulation to full state KF can be done without loss of generality in terms of using the micronavigation output as an aiding tool in the (integrated) navigation aiding apparatus 10.

The estimator (KF) in the navigation processor 40 models the relationship between the navigation states of the marine platform 100 (position, orientation, velocity) and the information provided by the micronavigation displacement measurements from the sonar processor 30.

In accordance with a further embodiment, the estimator (KF) of the navigation processor 40 models the relationship between the navigation states of the marine platform 100 (position, orientation, velocity) and the information provided by the one or more additional sensors 50.

The estimator (KF) of the navigation processor 40 is configured to estimate systematic errors in any measurements and calculations, including, but not limited to, micronavigation displacement measurements and/or installation geometry.

In accordance with a further embodiment of the navigation processor 40 the estimator (KF) is configured to incorporate additional states in order to calibrate different system parameters, including micronavigation scale factor errors, and transducer alignment errors.

The navigation processor 40 is according to one embodiment provided with means and/or software for predicting, between micronavigation displacement measurements, the different estimates and their error covariance, and updating every time a new measurement is accepted.

To achieve high accuracy and full utilization of micronavigation this imposes stringent requirement on the mathematical implementation and timing. The disclosed embodiments provide a solution for integrating micronavigation displacement measurements that accurately incorporates and utilizes the information available without the approximations and assumptions of prior art methods.

According to one embodiment, the micronavigation displacement measurements are utilized to reduce velocity error and hence position error of the navigation aiding apparatus 10, which in turn means reducing the position drift. Compared to conventional velocity aiding techniques (additional sensors), micronavigation provides a higher fidelity input.

According to one embodiment, the navigation processor 40 is provided with means and/or software to achieve this. While each micronavigation displacement measurement will be linked to their own states in the estimator (Kalman Filter), the actual processing steps are the same.

The navigation processor 40, for an iteration with a single micronavigation displacement measurement received from the sonar processor 30, is provided with means and/or software for, as a first step, registering and converting the micronavigation displacement measurements (delta positions) to estimator measurements, by converting the micronavigation displacement measurements in specified coordinate systems, in combination with transmit and receive times, to velocities. Similarly, the navigation processor 40 is provided with means and/or software for using displacement accuracies either directly or indirectly by converting displacement accuracies.

The representation in the different coordinate frames remain unchanged at this point, and the non-orthogonality is correctly treated when carrying out lever arm compensation and the estimator (KF) update, further described below.

In accordance with one embodiment, the navigation processor 40 is provided with means and/or software for performing micronavigation lever arm compensation as a part of the estimator (KF) measurement calculations. In an alternative embodiment, the navigation processor 40 is provided with means and/or software for performing micronavigation lever arm compensation as a part of the micronavigation displacement measurement registration.

The lever arm is made up by a static part from mechanical offsets from the integrated navigation aiding apparatus 10 origin to the transmitter 21 and multiple receiver arrays 22a-b, and a dynamic part due to varying overlap from the to surge motion of the marine platform 100.

The mentioned lever arm calculation compensates for the effect the lever arm has on the mentioned micronavigation displacement measurements, and associated compensation, hereunder; angular velocity of the marine platform 100, the intermediate rotation occurring in the duration between the disparate times of patch orientation and the displacement estimations, and the rotational misalignment of the receiver array 22a-b relative to the navigation frame.

The navigation processor 40 according to one embodiment further provided with means and/or software for decomposing the mentioned lever arm effect in either the receiver array 22a-b frame or patch frame, for respective micronavigation displacement measurements.

The navigation processor 40 is further provided with means and/or software for calculating corrections based on estimates of the estimator (KF) observation model and calculated accuracies in the micronavigation displacement and associated coordinate frame calculations.

According to one embodiment, the accuracies in the micronavigation displacement and associated coordinate frame calculations are implemented in the navigation processor 40 as a function of the navigation aiding apparatus 10 velocity (geographical navigation frame), the micronavigation surge velocity (receiver array 22a-b frame), and the micronavigation sway velocity (patch frame). These are lever arm compensated as discussed above.

The navigation processor 40 is further provided with means and/or software compensating for the non-orthogonality of the different micronavigation displacement measurements. The means and/or software is adapting the micronavigation displacement measurements in the navigation frame by taking into account the intermediate rotation occurring in the duration between the disparate times of patch orientation and the micronavigation displacement measurements.

In accordance with a further embodiment of the navigation processor 40, the means and/or software is further configured to taken into account the rotational misalignment of the receiver array 22a-b relative to the navigation frame, and/or orientation of acoustic estimated patch coordinate system (spatial extension as well as intensity distribution).

The navigation processor 40 is further provided with means and/or software for correcting the micronavigation displacement measurement in the receiver array 22a-b frame by applying the orientation of acoustic estimated patch coordinate system.

The accuracies in the micronavigation displacement and orientation measurements provided by the navigation processor 40, and the output of the estimator observation model, is decomposed in the patch frame, in two dimensions as patch-x and patch-y, as discussed above.

The estimator observation model of the estimator (KF) of the navigation processor 40 thus describes the connection between the navigation states, the errors of the navigation states, and the modelled accuracies of the micronavigation displacement measurements and patch orientations.

According to a further embodiment, the estimator observation model, for calibration, is configured with calibration states and coupling of those states.

In one embodiment, the errors of the navigation states are decomposed in the geographical navigation frame. For this embodiment, the estimator observation model (matrix) takes into account the same effects as in the error in the measurements derivation. In more detail, taking into account the intermediate rotation occurring in the duration between the disparate times of the patch orientation and the micronavigation displacement measurements.

In accordance with a further embodiment, the estimator observation model also takes into account the rotational misalignment of the receiver array 22a-b relative to the navigation frame, and/or orientation of acoustic estimated patch coordinate system (spatial extension as well as intensity distribution).

The micronavigation part of the estimator observation model (matrix) in the navigation processor 40 is according to one embodiment parameterized, such as, but not limited to, linearization, curve adaption/fitting, etc., around the solution of the navigation equations, and the patch angles. It includes the rotation (matrix) from the receiver array 22a-b frame to the patch frame (constructed from the patch angles), and the derivatives of this matrix with respect to the patch angles.

In an alternative embodiment, the mentioned estimator observation matrix is implemented by a non-linear estimator, such that the mentioned parametrization is not required.

According to one embodiment, the corrections are provided as input to a controller or control system controlling the motion of the marine platform 100 directly or indirectly. The corrections may be accompanied by estimator gains, such as Kalman Filter gains when a Kalman Filter is used.

In accordance with a further embodiment, the navigation processor 40 is provided with means and/or software for converting the micronavigation displacement measurements to a velocity measurement applicable in a preset/desired time interval. This embodiment may be combined with using inertial measurement unit measurements, e.g., to modify or correct the time of measurement to a better place than the preset/desired time interval.

According to a further embodiment, the navigation processor 40 is provided with means and/or software for estimating an expected micronavigation displacement measurements by integrating inertial measurement unit measurements, and comparing the two.

In accordance with a further embodiment the navigation processor 40 is provided with means and/or software for using micronavigation displacement measurements close to optimal by using extra states to “remember the position and its correlations” at the start of a micronavigation displacement measurement.

The three latter embodiments show that there is a variety of possible modifications of the disclosed embodiments, that may be tailored to the specific application.

For the micronavigation part, the navigation processor 40 is provided with means and/or software for calculating observation noise matrix based on the reported accuracies by the sonar processor 30, optionally in combination with configuration parameters, such as, but not limited to, added white noise/bias model std., motion/rotation scaled white noise/bias, range scaled white noise/bias, etc.

Similar as for the observation matrix, the observation noise matrix is found by that the navigation processor 40 is provided with means and/or software for parametrizing the observation equation around the navigation equation solution and the patch angles. Given the parameterized model, the observation noise matrix can be found using similarity transform and the accuracy of the surge and sway measurements, and the patch angles.

The disclosed embodiments provide a navigation aiding method and apparatus 10 being more precise than prior art solutions. By providing more accurate navigation data, this will also enhance the accuracy of other sensors arranged to the marine platform 100, such as images/visualization of payload data.

The disclosed embodiments provide a navigation aiding method and apparatus 10 being more robust against seafloor terrain variations, compared to prior art solutions.

The disclosed embodiments also provide a navigation aiding method and apparatus 10 being more robust against non-linear marine platform 100 dynamics, such as, e.g., during turn operations, compared to prior art solutions.

Provided herein is a navigation aiding method and apparatus 10 being more robust against inhomogeneous distribution of scatterers over the patch, compared to prior art solutions.

Provided herein is a navigation aiding method and apparatus for enabling a higher degree of integration than previously described solutions.

The above discussed embodiments can be modified or combined to form new embodiment within the scope of the attached claims.

The disclosed embodiments can be implemented with a single-sided sonar.

The use of additional sensors 50 will provide measurements allowing the navigation processor 30 to deduce marine platform 100 orientation (all three degrees of freedom). This may for instance be an inertial measurement unit (IMU) or a gyrocompass, but also other sensor or sensor system can be used. According to a further embodiment, it comprises using additional sensors 50 to increase the overall apparatus robustness and accuracy. For instance, a Doppler velocity log (DVL) may be integrated. A pressure sensor is another example for, especially when the marine platform 100 is a submersible platform, to enable reduction of the vertical position error.

The trigger control unit can, in principle, use micronavigation displacement measurements from the sonar processor 30 to generate triggers. Additional sensors 50 are needed for providing an initial velocity estimate.

The sound speed sensor may measure sound speed directly, or through computations from other measurements, such as a conductivity/temperature/depth (CTD) sensor.

Instead of an Extended Kalman Filter as the estimator, the navigation processor can use any non-linear estimator, such as unscented Kalman filter, or particle filter, machine learning algorithms such as CNN, optimization algorithms, RT-smoothing, in delayed navigation, etc. As some estimators lack some of the described features that the Kalman filter as estimator provides, there may be required additional actions.

Instead of using error states, the navigation processor can use estimator states, directly representing the marine platform's 100 position, orientation, velocity and angular rates.

The disclosed embodiments may further use dynamic patch selection, which will improve the navigation performance compared to static dynamic patch selection.

1-35. (canceled)

36. A method for enhanced navigation of a marine platform (100) over a seafloor (200), comprising:
performing micronavigation displacement measurements and associated coordinate frame calculations by using at least one one-sided or two-sided sonar comprising at least one transducer (20a, 20b) comprising at least one transmitter (21) configured to transmit pings and at least two parallel receiver arrays (22a, 22b) each arranged roughly parallel to a travel direction of the marine platform (100), the receiver arrays (22a, 22b) being configured to register echo of pings reflected from the seafloor (200), wherein the micronavigation displacement measurements are performed along the primary axes of two different coordinate systems in the form of a receiver array (22a, 22b) frame and a patch frame, the patch frame being located at an acoustic center of mass for an instance of seafloor illumination;
calculating a three-dimensional orientation of the receiver array (22a, 22b) frame relative to the patch frame; and
calculating accuracies for all micronavigation displacement measurements and associated coordinate frame calculations, wherein
the micronavigation displacement measurements are processed in an estimator observation model, modelling the relationship between position, orientation, and velocity of navigation states of the marine platform (100) and the micronavigation displacement measurements, coordinate frames and accuracies, and the output of the estimator observation model is used to correct navigation data for the marine platform (100).

37. The method according to claim 36, wherein the output of the estimator observation model is used as input for a controller or control system controlling motion of the marine platform (100) or a vessel or craft towing the marine platform (100).

38. The method according to claim 36, further comprising
registering transmit and receive times for pings,
calculating patch frame angles for each ping, and
calculating delta positions for each pair of successive pings enabling reduction of velocity error and hence position error.

39. The method according to claim 36, further comprising correlating along-track elements to estimate azimuth direction for line of sight.

40. The method according to claim 36, further comprising using ping data to estimate the scattering distribution over a patch to estimate azimuth direction for line of sight.

41. The method according to claim 36, further comprising
using ping data to estimate the seafloor (200) depth at multiple azimuth directions and ranges to estimate the effective seafloor (200) slope,
using the effective seafloor (200) slope together with line of sight and a normal vector of the seafloor (200) to determine plane of sight, thereby determining the patch frame defined by Y-axis along the line of sight, with the X-axis pointing along the seafloor (200) and with the Z-axis normal to these in the plane of sight.

42. The method according to claim 36, further comprising using the estimator observation model to model the relationship between position, orientation, and velocity of navigation states of the marine platform (100) and the measurements or states from additional sensors (50).

43. The method according to claim 36, further comprising using the estimator observation model to estimate systematic errors in the measurements and calculations.

44. The method according to claim 36, further comprising using a Kalman filter or an extended Kalman filter as the estimator observation model.

45. The method according to claim 36, further comprising
predicting estimates of the estimator observation model and their error covariance between micronavigation displacement measurements and the associated coordinate frame measurements, and
updating the different estimates and their error covariance every time a new micronavigation displacement measurement and the associated coordinate frame measurements are registered.

46. The method according to claim 36, further comprising converting the micronavigation displacement measurements to estimator observation model calculations by converting displacements in combination with transmit and receive times to velocities.

47. The method according to claim 36, further comprising using displacement accuracies either directly or indirectly by converting displacement accuracies in combination with transmit and receive times to velocity accuracies.

48. The method according to claim 36, further comprising performing micronavigation lever arm compensation as part of the estimator observation model calculations.

49. The method according to claim 48, further comprising calculating the lever arm compensation by a static part from mechanical offsets from a navigation aiding apparatus origin to the transmitter (21) and multiple receiver arrays (22a, 22b) of the sonar, and a dynamic part due to varying overlap caused by surge motion of the marine platform (100).

50. The method according to claim 36, further comprising accounting for three-dimensional rotation between the receiver array (22a, 22b) frame and the patch frame by rotation of the patch frame relative to the receiver array (22a, 22b) frame between transmit and receive times for two consecutive pings.

51. The method according to claim 50, further comprising using the estimator observation model to describe a connection between navigation states of the marine platform (100), errors of the navigation states of the marine platform (100), and accuracies of the micronavigation displacement measurements and rotation of the patch frame relative to the receiver array (22a, 22b) frame.

52. The method according to claim 51, further comprising calibrating apparatus parameters, hereunder scale factor errors and transducer alignment errors, by incorporating additional states in the estimator observation model.

53. The method according to claim 47, further comprising calculating an observation noise matrix based on the calculated accuracies alone or in combination with configuration parameters by parametrizing an observation equation around a navigation equation solution and patch angles.

54. The method according to claim 46, further comprising performing one or more of the following additional steps:
converting the micronavigation displacement measurements to a velocity measurement applicable in a preset or desired time interval,
estimating expected micronavigation displacement measurements by integrating inertial measurement unit measurements, and comparing them with the micronavigation displacement measurements, and
using extra states in the estimator observation model to remember position and its correlations from start to completion of the micronavigation displacement measurement.

55. An apparatus (10) for providing enhanced navigation of a marine platform (100) over a seafloor (200), comprising
at least one one-sided or two-sided sonar with at least one transmitter (21) configured to transmit pings and at least two parallel receiver arrays (22a, 22b) each arranged roughly parallel to a travel direction of the marine platform (100), the receiver arrays (22a, 22b) being configured to register echo of pings reflected from the seafloor (200), the sonar being configured to perform micronavigation displacement measurements and associated coordinate frame calculations; and
a navigation processor (40) provided with means or software for calculating three-dimensional orientation of the receiver array (22a, 22b) frame relative to the patch frame and calculating accuracies for all micronavigation displacement measurements and associated coordinate frame calculations, the navigation processor (40) further comprising an estimator observation model configured to process the micronavigation displacement measurements, modelling the relationship between position, orientation, and velocity of navigation states of the marine platform (100) and the micronavigation displacement measurements, coordinate frames and accuracies, wherein
the output of the estimator observation model is used for correction of navigation data for the marine platform (100), and
the apparatus (10) is configured to perform the micronavigation displacement measurements along the primary axes of two different coordinate systems in the form of a receiver array (22a, 22b) frame and patch frame, the patch frame being located at the acoustic center of mass for an instance of seafloor illumination.

56. The apparatus (10) according to claim 55, wherein the calculated corrections are provided to a controller or control system controlling motion of the marine platform (100) or a vessel or craft towing the marine platform (100).

57. The apparatus (10) according to claim 55, further comprising a sonar processor (30) configured for performing micronavigation displacement measurements between sonar transmissions and a coordinate frame for each such measurement.

58. The apparatus (10) according to claim 55, further comprising a trigger control unit (60) configured to control a trigger signal for the at least one transmitter (21) each time the marine platform (100) and navigation aiding apparatus (10) is estimated to have travelled a fixed distance (D) in an earth fixed coordinate system based on velocity estimates from the navigation processor (40).

59. The apparatus (10) according to claim 57, wherein the sonar processor (30) is provided with means or software configured for one or more of:
correlating signals between overlapping phase centers,
providing an estimate of across-track displacement by correlating time series from the overlapping phase centers,
providing an estimate of along-track platform displacement by comparing correlation of time series with different displacements,
finding the direction of each micronavigation displacement measurement and addressing these during integration, by performing further correlations of the micronavigation displacement measurements,
correlating time series from the receiver arrays (22a, 22b), the time series being beam-formed in or delayed to a given azimuthal direction and corrected for shift and dilation between the receiver arrays (22a, 22b) providing calculation of an angle from the sonar transducers (20a, 22b) to the seafloor (200) in that direction,
performing calculations at multiple across-track ranges to calculate across-track slope of the seafloor (200),
performing calculations with data beam-formed in different azimuthal directions to calculate along-track slope of the seafloor (200),
determining the distribution of echo strength as a function of azimuth angle, and
estimating accuracy of the micronavigation displacement measurements and the associated coordinate frame measurements through further computations, using the normalized cross-correlation coefficients.

60. The apparatus (10) according to claim 55, wherein the estimator observation model is configured to model the relationship between position, orientation, and velocity of navigation states of the marine platform (100) and the measurements or states from additional sensors (50).

61. The apparatus (10) according to claim 55, wherein the navigation processor (40) is provided with means or software configured for one or more of:
registering and converting the micronavigation displacement measurements to estimator measurements by converting micronavigation displacements in combination with transmit and receive times to velocities,
converting micronavigation displacement accuracies either directly or indirectly by converting displacement accuracies in combination with transmit and receive times to velocity accuracies,
performing micronavigation lever arm compensation as part of the estimator observation model calculations, and
compensating for non-orthogonality between the receiver array (22a, 22b) frame and the patch frame by rotation of the patch frame relative to the receiver array (22a, 22b) frame between transmit and receive times for two consecutive pings.

62. The apparatus (10) according to claim 55, wherein the navigation processor (40) is provided with means or software configured for one or more of:
converting the micronavigation displacement measurements to a velocity measurement applicable in a preset or desired time interval,
estimating expected micronavigation displacement measurements by integrating inertial measurement unit measurements, and comparing them with the micronavigation displacement measurements, and
using extra states in the estimator observation model to remember position and its correlations from to completion of the micronavigation displacement measurements.
